(19) United States
(12) Patent Application Publication
(10) Pub. No.: US 2013/0077919 A1
(43) Pub. Date: Mar. 28, 2013

(54) OPTICAL-ELECTRICAL CONNECTOR HAVING A MAGNETIC MEMBER

(71) Applicants: JUN ZONG, Kunshan (CN); CHI-MING CHEN, New Taipei (TW); YA-DONG ZHU, Kunshan (CN); YUN-CHENG HOU, New Taipei (TW)

(72) Inventors: JUN ZONG, Kunshan (CN); CHI-MING CHEN, New Taipei (TW); YA-DONG ZHU, Kunshan (CN); YUN-CHENG HOU, New Taipei (TW)

(73) Assignee: HON HAI PRECISION INDUSTRY CO., LTD., New Taipei (TW)

(21) Appl. No.: 13/630,175

(22) Filed: Sep. 28, 2012

(30) Foreign Application Priority Data
Sep. 28, 2011 (CN) 201110294645.7

(51) Int. Cl. G02B 6/42

(52) U.S. Cl. 385/89; 385/93

(57) ABSTRACT

An optical-electrical connector (100) includes a housing (11), a circuit board (3) received in the housing and having a transducer for bidirectional optical-electrical signal conversion, a lens member (42) mounted on the circuit board, a ferrule (43) receiving a number of optical channels and having a resisting face (431), and a magnetic member (51). The ferrule is situated behind the lens member and aligned with the lens member along a front-to-back direction. The magnetic member has a metal sheet (511) and at least one magnetic component (513) secured in the housing. The metal sheet abuts against the resisting face of the ferrule under a magnetic force provided by the at least one magnetic component, to provide a forward resilient force to the ferrule for fixing the ferrule to the lens member.

### BACKGROUND OF THE INVENTION

1. Field of the Invention

The present invention relates to an optical-electrical connector, and more particularly to an optical-electrical connector having a magnetic member for providing a low loss optical coupling between the fibers and the lens member applied in optical signal transmission.

2. Description of Related Art

U.S. Pat. No. 7,794,156 issued to Wang et al. on Sep. 14, 2010, U.S. Pat. No. 7,581,891 issued to Wang on Sep. 1, 2009, and U.S. Pat. No. 7,401,985 issued to Aronson et al. on Jul. 22, 2008 discloses an optical-electrical connector. The optical-electrical connector includes a housing, a circuit board having a transducer, a lens and a ferrule received in the housing, and a plurality of fibers mounted in the ferrule. The ferrule is aligned with the lens to align the plurality of fibers with the lens for optical signal transmission. The transducer is used for bidirectional optical-electrical signal communication.

It is hard to align the ferrule with the lens reliably without an exerted force. It would result in a great loss of optical coupling between the fibers and the lens.

Hence, an optical-electrical connector having a magnetic member is desired.

### SUMMARY OF THE INVENTION

Accordingly, an object of the present invention is to provide an optical-electrical connector having a magnetic member providing a resilient force to the ferrule to align the ferrule with the lens member reliably for low loss optical transmission.

In order to achieve the object set forth, an optical-electrical connector includes a housing, a circuit board received in the housing and having a transducer for bidirectional optical-electrical signal conversion, a lens member mounted on the circuit board, a ferrule receiving a plurality of optical channels and having a resisting face, and a magnetic member. one of the lens member and the ferrule has a guide pin, and another one of the lens member and the ferrule has a guide hole. The ferrule is situated behind the lens member within the housing and aligned with the lens member along a front-to-back direction via an engagement between the guide pin and the guide hole. The magnetic member has a metal sheet and at least one magnetic component secured in the housing. The metal sheet abuts against the resisting face of the ferrule under a magnetic force provided by the at least one magnetic component, to provide a forward resilient force to the ferrule for fixing the ferrule to the lens member.

The flexible metal sheet would permanently provide an invariable resilient forward force to the ferrule for fixing the ferrule to the lens member, when the optical-electrical connector is plugged into the mating connector and mated with the mating connector in use, and unmated with the mating connector when unused. Therefore, the optical channels in the ferrule could be aligned with the lens member along the front-to-back direction reliably to provide a low loss optical communication.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing an optical-electrical connector in accordance with a first embodiment of the present invention;

FIG. 2 is a partially assembled perspective view showing the optical-electrical connector shown in FIG. 1, with a cover separated from a housing;

FIG. 3 is a view similar to FIG. 2, taken from another aspect;

FIG. 4 is an exploded view showing the optical-electrical connector;

FIG. 5 is a perspective view showing a ferrule;

FIG. 6 is an exploded perspective view showing a magnetic member in the first embodiment;

FIG. 7 is an assembled perspective view showing the magnetic member referred in a second embodiment; and

FIG. 8 is an exploded view showing the magnetic member referred in the second embodiment.

### DETAILED DESCRIPTION OF THE PREFERRED EMBODIMENT

Reference will now be made in detail to the preferred embodiment of the present invention.

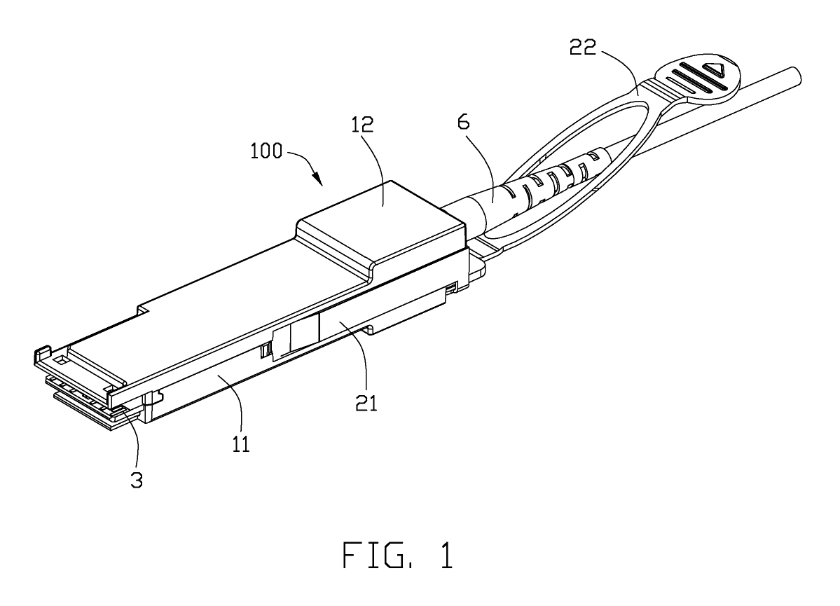

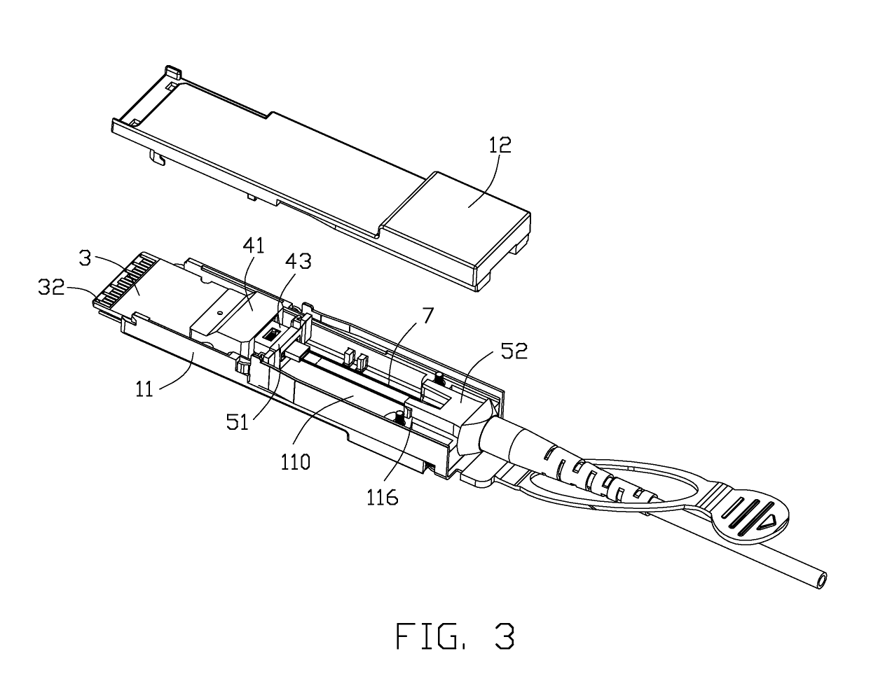

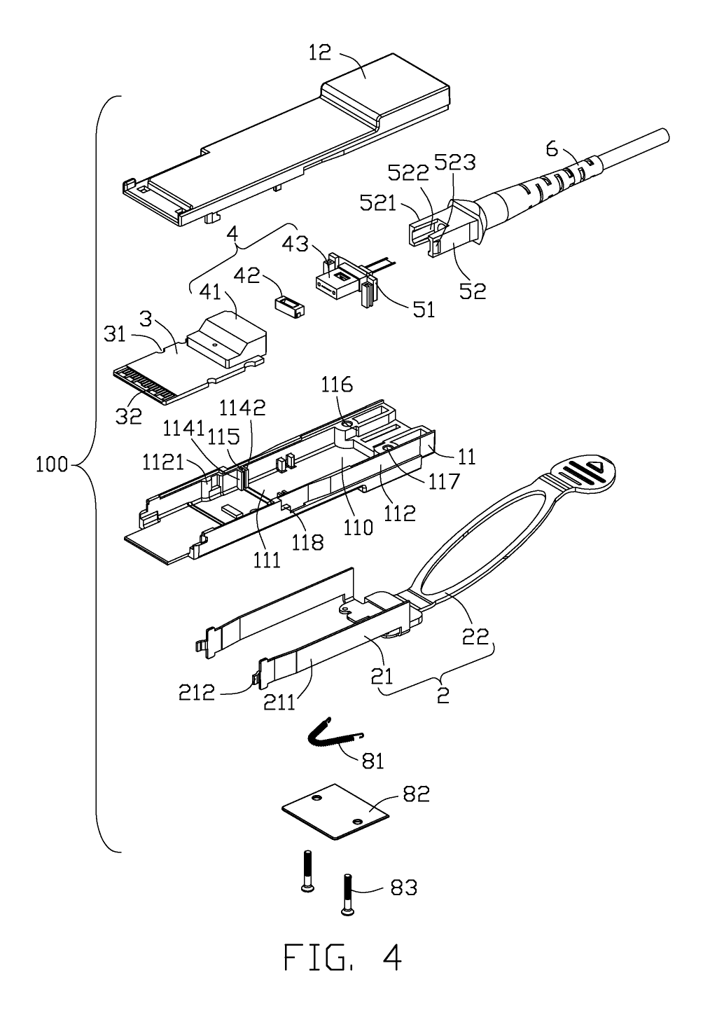

Referring to FIGS. 1-6, an optical-electrical connector 100 in accordance with a first embodiment of the present invention includes a housing 11 defining a cavity 110, a cover 12 attached to an upper portion of the housing 11, a circuit board 3, an optical member 4, a magnetic member 51, and a mounting portion 52 received in the cavity 110 of the housing 11, a releasing mechanism 2, a restoring spring 81, a cover plate 82, a pair of screws 83 and a cable jacket 6.

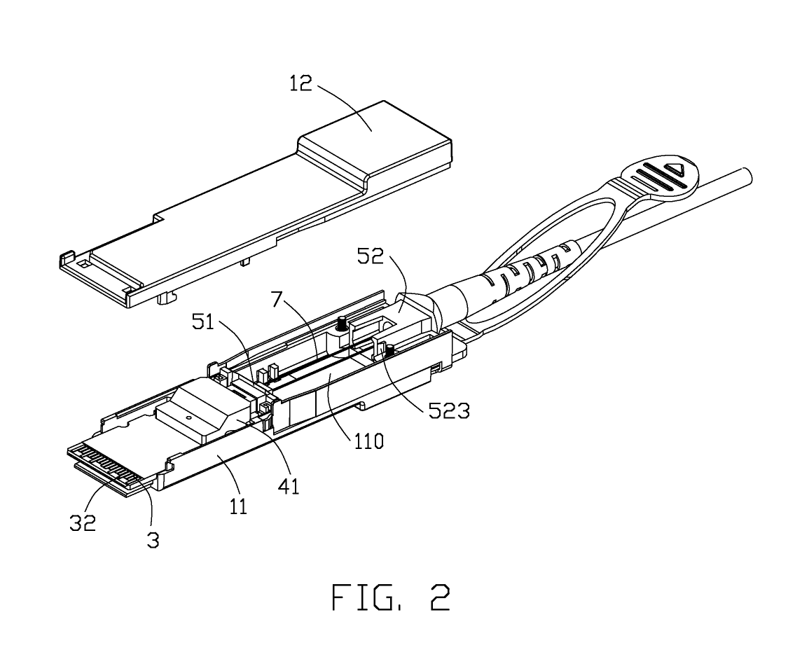

Referring to FIGS. 2-5, the housing 11 includes a bottom wall 111 and a pair of side walls 112. Each side wall 112 has a first and a second securing tabs 1141, 1142 projecting inwardly toward the cavity 110, a securing recess 115 between the first and second securing tabs 1141, 1142, a post 1121 in front of the first securing tab 1141, a shoulder portion 116 behind the second securing tab 1142, and an up-to-bottom extending mounting hole 117. Each side wall 112 further has a cooperating recess 118 defined at an outer face thereof

The circuit board 3 has a plurality of conductive pads 32 formed at a front portion thereof for contacting with a mating connector (not shown), a transducer (not shown) for bidirectional optical-electrical signal conversion and an amplifier (not shown) formed at a rear portion thereof, and a pair of cutouts 31 defined at opposite side edges thereof.

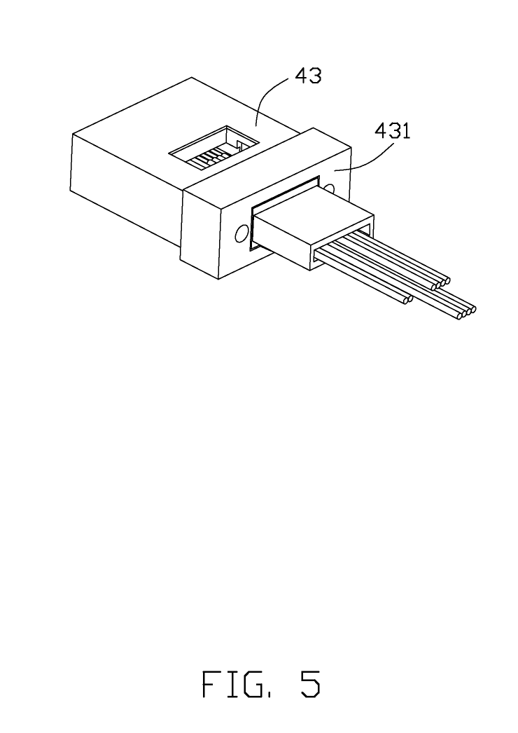

The optical member 4 includes a lens member 42, a package 41 enclosing the transducer and the lens member 42, and a ferrule 43 carrying a plurality of optical channels. In conjunction with FIG. 5, the ferrule 43 has a resisting face 431. The plurality of optical channels are constituted into a plurality of fibers 7 shrouded by the cable jacket 6 in this embodiment, and could be constituted by waveguides in another embodiment. One of the lens member 42 and the ferrule 43 has two guide pins (not shown), and another one of the lens member 42 and the ferrule 43 has two guide holes (not labeled) respectively engaged with the guide pins.

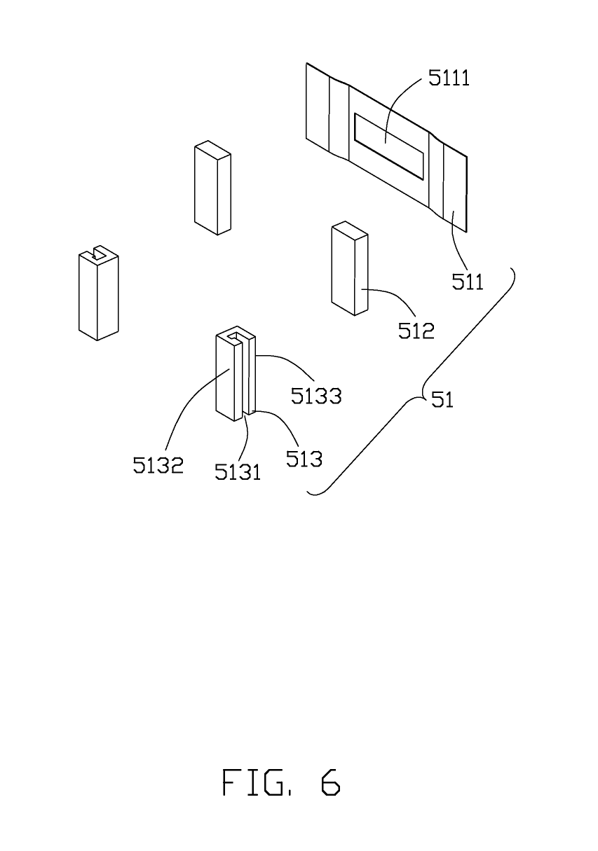

In conjunction with FIG. 6, in the first embodiment, the magnetic member 51 includes a flexible metal sheet 511 defining a window 5111, a pair of stiffeners 512 made from metallic material and a pair of magnetic components 513. Each magnetic component 513 comprises a first wall 5132, a second wall 5133 parallel to the first wall 5132, and a slot 5131 between the first and second walls 5132, 5133. In assembly of the magnetic member 51, the pair of stiffeners 512 are soldered onto opposite side portions of the flexible metal sheet 511. The pair of stiffeners 512 are respectively absorbed to the second walls 5133 of the magnetic components 513 under a magnetic force.

The mounting portion 52 includes a pair of beam portions 521 and an opening 522 between the pair of beam portions 521. Each beam portion 521 has a hook portion 523 formed at a free end thereof

The releasing mechanism 2 includes an operator 21 having a pair of beam portions 211 each having a releasing portion 212, and an actuator 22 insert molded with the operator 21.

Referring to FIGS. 1-6, in assembling of the optical-electrical connector 100, the lens member 42 is adhered on the circuit board 3 by glue and is disposed above the transducer and the amplifier. The package 41 is adhered on the circuit board 3 by glue for enclosing the lens member 42, the transducer and the amplifier. The circuit board 3 together with the transducer, the amplifier, the lens member 42 and the package 41 is fixed in the cavity 110 of the housing 11, with the cutouts 31 latching with the posts 1121. The ferrule 43 is situated behind the lens member 42 and aligned with the lens member 42 along a front-to-back direction via an engagement between the guide pins and the guide holes. The magnetic member 51 is secured in the cavity 110, with the first walls 5132 of the magnetic components 513 confined in the securing recesses 115, and the slots 5131 latching with the second securing tabs 1142. The flexible metal sheet 511 abuts against the resisting face 431 of the ferrule 43 and providing a resilient forward force to the ferrule 43, under the magnetic force exerted to the stiffeners 512 from the magnetic components 513. The mounting portion 53 is received in the cavity 110, with the hook portions 533 engaging with the shoulder portions 116. The cover 12 is attached to an upper portion of the housing 11.

The releasing mechanism 2 is assembled to the housing 11, with the releasing portions 212 received in the cooperating recesses 118. The restoring spring 81 and the cover plate 82 are assembled to the housing 11. The screws 83 are mounted through the mounting holes 117 to fasten the cover 12 to the housing 11.

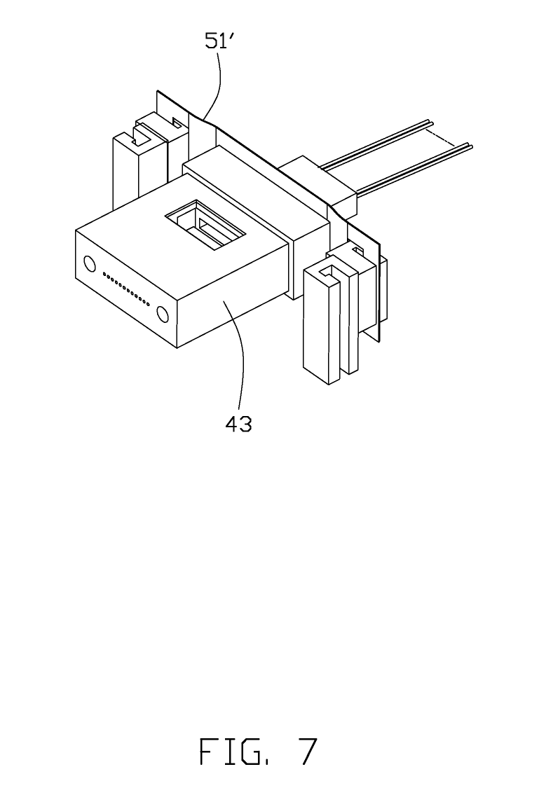

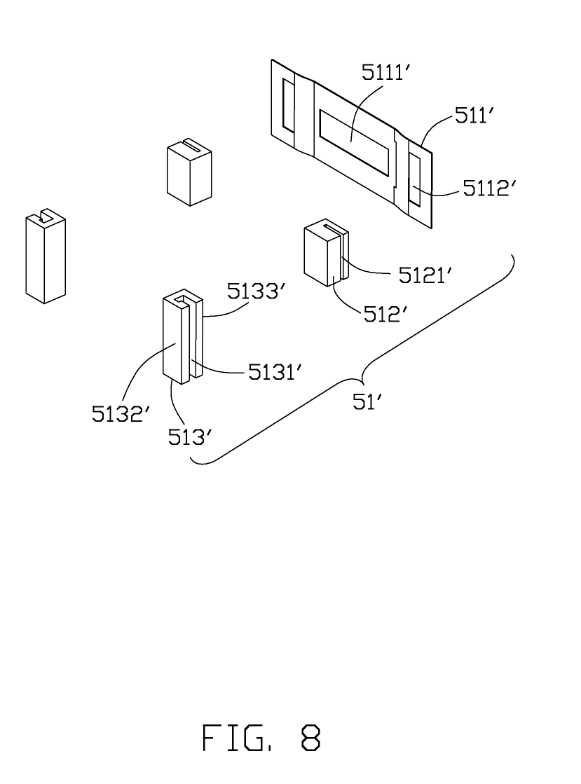

Referring to FIGS. 7 and 8, the magnetic member 51′ referred in a second embodiment has a configuration different from that of the first embodiment. The magnetic member 51′ includes a flexible metal sheet 511′ defining a window 5111′ and a pair of openings 5112′ at opposite sides of the window 5111′, a pair of stiffeners 512′ made from metallic material and a pair of magnetic components 513′. Each stiffener 512′ defines a slit 5121′. Each magnetic component 513′ comprises a first wall 5132′, a second wall 5133′ parallel to the first wall 5132′, and a slot 5131′ between the first and second walls 5132′, 5133′. In assembling of the magnetic member 51′, the pair of stiffeners 512′ are respectively inserted in the openings 5112′, with the pair of slits 5121′ respectively engaging with the side portions of the flexible metal sheet 511′. The pair of stiffeners 512′ are respectively absorbed to the second walls 5133′ of the magnetic components 513′ under a magnetic force.

The flexible metal sheet 511, 511′ would permanently provide an invariable resilient forward force to the ferrule 43 for fixing the ferrule 43 to the lens member 42, when the optical-electrical connector 100 is plugged into the mating connector and mated with the mating connector in use, and unmated with the mating connector when unused. Therefore, the fibers 7 in the ferrule 43 could be aligned with the lens member 42 along the front-to-back direction reliably to provide a low loss optical communication.

The flexible metal sheet 511, 511′ could be optionally formed into other printed circuit board. A resilient force provided by the flexible metal sheet 511, 511′ would be more soft and more flexible than that provided by the printed circuit board.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical-electrical connector comprising:
a housing;
a circuit board received in the housing and having a transducer for bidirectional optical-electrical signal conversion;
a lens member mounted on the circuit board;
a ferrule receiving a plurality of optical channels and having a resisting face, one of the lens member and the ferrule having a guide pin, and another one of the lens member and the ferrule having a guide hole, said ferrule being situated behind the lens member within the housing and aligned with the lens member along a front-to-back direction via an engagement between the guide pin and the guide hole; and
a magnetic member having a metal sheet and at least one magnetic component secured in the housing, said metal sheet abutting against the resisting face of the ferrule under a magnetic force provided by the at least one magnetic component, to provide a forward resilient force to the ferrule for fixing the ferrule to the lens member.

2. The optical-electrical connector as claimed in claim 1, further comprising a cover attached to an upper portion of the housing.

3. The optical-electrical connector as claimed in claim 2, wherein there are a pair of magnetic components, said metal sheet constituted of a flexible metal sheet, said magnetic member having a pair of stiffeners mounted at opposite sides of the flexible metal sheet and absorbed by the pair of magnetic components under said magnetic force.

4. The optical-electrical connector as claimed in claim 3, wherein said pair of stiffeners are soldered onto opposite sides of the flexible metal sheet.

5. The optical-electrical connector as claimed in claim 3, wherein said flexible metal sheet defining a pair of openings and each stiffener defines a slit, said pair of stiffeners respectively inserted in the pair of openings, with the pair of slits respectively engaging with opposite sides of the flexible metal sheet.

6. The optical-electrical connector as claimed in claim 3, wherein said housing includes a pair of side walls each having a first and a second securing tabs and a securing recess between the first and second securing tabs, each magnetic component engaging with the securing recess.

7. The optical-electrical connector as claimed in claim 6, wherein each magnetic component having a first wall, a second wall, and a slot between the first and second walls for latching with the second securing tab, said first wall being confined in the securing recess, said second wall being attached to a rear side of the second securing tab for absorbing the stiffener.

8. The optical-electrical connector as claimed in claim 1, wherein one of said circuit board and the housing has a cutout, and the other one of the circuit board and the housing has a post engaging with the cutout.

9. The optical-electrical connector as claimed in claim 1, wherein said plurality of optical channels are constituted into a plurality of fibers, said optical-electrical connector comprising a cable jacket shrouding the fibers.

10. The optical-electrical connector as claimed in claim 9, further comprising a mounting portion connected with the cable jacket and including a pair of hook portions, said housing comprising a pair of shoulder portions respectively engaging with the hook portions.

11. The optical-electrical connector as claimed in claim 1, further comprising a package mounted on the circuit board for enclosing the transducer and the lens member.

12. The optical-electrical connector as claimed in claim 11, wherein said lens member and the package are respectively adhered on the circuit board by glue.

13. A connector comprising:
a housing enclosing an optical member,
said optical member including:
a lens member enclosed in a package;
a ferrule located behind the lens member in a front-to-back direction and defining a plurality of optical channels equipped with corresponding optical fibers;
a magnetic subassembly defining a front part and a rear part along said front-to-back direction and attractable to each other in said front-to-back direction; wherein
the first part is secured relative to the housing while the second part is associated with the ferrule so as to have the ferrule constantly urged toward and abut against the lens member for assuring coupling between the lens member and the ferrule.

14. The connector as claimed in claim 13, wherein the first part is a permanent magnet while the second part a magnetic attraction metal.

15. The connector as claimed in claim 14, wherein said magnetic subassembly further includes a flexible metal sheet carrying the ferrule for forward softly urging said ferrule toward the lens member.

16. The connector as claimed in claim 13, wherein said lens member is directly mounted to a printed circuit board which is enclosed in the housing for mating with a complementary connector.

17. A connector comprising:
a housing enclosing an optical member,
said optical member including:
a lens member enclosed in a package;
a ferrule located behind the lens member in a front-to-back direction and defining a plurality of optical channels equipped with corresponding optical fibers;
a magnetic subassembly defining a front part and a rear part along said front-to-back direction and generating a magnetic force to imposed upon therebetween in the front-to-back direction; wherein
the first part is associatively attached to the housing while the second part is associated with the ferrule so as to have the ferrule constantly urged toward and abut against the lens member for assuring coupling between the lens member and the ferrule.

18. The connector as claimed in claim 17, wherein said magnetic subassembly further includes a flexible sheet to urge the ferrule forward by said force.

19. The connector as claimed in claim 18, wherein said force is an attraction force.

20. The connector as claimed in claim 17, wherein the first part is a permanent magnet and is located in front of the second part.
